(19) United States
(12) Patent Application Publication
(10) Pub. No.: US 2012/0144912 A1
(43) Pub. Date: Jun. 14, 2012

(54) Portion Control System for Weight Loss and Maintenance

(75) Inventors: Steven Kates, Los Angeles, CA (US); Myles Berkowitz, Los Angeles, CA (US)

(73) Assignee: LifeSize, LLC, Los Angeles, CA (US)

(21) Appl. No.: 13/319,300

(22) PCT Filed: Dec. 24, 2009
(86) PCT No.: PCT/US09/69542

§ 371 Date: Nov. 7, 2011

Related U.S. Application Data
(60) Provisional application No. 61/140,759, filed on Dec. 24, 2008.

(51) Int. Cl. G01F 17/00

(52) U.S. Cl. 73/149

(57) ABSTRACT

A set of volumetric measuring devices or portioning scoops are used in a weight loss and weight maintenance program. Each scoop is configured to measure a single portion size for any particular food in a respective food category. Single portions of foods are measured by the scoop for the category that limits the calorie value of the food portion within a small range. For some foods, a single portion size may be one measured volume of a scoop, whereas for other foods a single portion may two or more measured volumes of the scoop. Over time (e.g., a week or a month), the calorie intake from foods measured with a particular scoop will average to a desired amount within the parameters of the program. A chart may be used in conjunction with the scoops depicting the respective categories, foods in each category of food, and a number of volumes of each scoop corresponding to a portion size.

### CROSS REFERENCE TO RELATED APPLICATIONS

This application claims the benefit of priority pursuant to 35 U.S.C. §119(e) of U.S. provisional application No. 61/140,759 filed 24 Dec. 2008 entitled “Portion control system for weight loss and maintenance,” which is hereby incorporated herein by reference in its entirety.

### BACKGROUND

Dietary portion sizes, energy intake, dietary fat, and fast food consumption have all increased significantly since the 1970's and in particular over the past two decades. For example, between 1977 and 1996, food portion sizes increased both inside and outside the home for all categories except pizza. The energy intake and portion size of salty snacks increased by 93 kcal (from 1.0 to 1.6 oz [28.4 g to 45.4 g]), soft drinks by 49 kcal (13.1 to 19.9 fl oz [387.4 ml to 588.4 ml]), hamburgers by 97 kcal (5.7 to 7.0 oz [161.6 g to 198.4 g]), French fries by 68 kcal (3.1. oz to 3.6 oz [87.9 g to 102.1 g]), and Mexican food by 133 kcal (6.3 oz to 8.0 oz [178.6 g to 226.8 g]). See Nielsen, S. J. and Popkin, B. M., Patterns and Trends in Food Portion Sizes, 1977-1998. JAMA. 2003; 289:450-453.

Some studies suggest that the average American consumes 1,000 kg (2,200 lb) of food per year containing an estimated 3,747 kcal per day. The Food and Drug Administration (FDA) recommends an average daily consumption of 2,000 to 2,500 kcal a day, much less than the actual typical American diet. Based upon preliminary data, there are estimates suggesting that the average American consumes 33% of their total calories in junk food. In contrast, the average Italian consumes approximately 2,162 kcal/day, which is approximately 73% fewer calories than the average American. Many studies suggest that two-thirds of Americans are overweight and one-third of those are considered obese. According to the World Health Organization, the United States ranks no. 9 in the world with 74.1% of the population being overweight or obese. In contrast, Italy ranks no. 111 with 45% of the population overweight or obese.

In view of this epidemic, numerous diets and weight lost systems have been proposed and tried, but obviously with limted or minimal effect. While people can and do lose weight on diets, clearly diets and eating programs do not work to keep weight off lifelong because people are gaining back the weight lost on diets.

Charts, books, pictures, cards and other two-dimensional products have been developed which give people an idea of what proper portion sizes should be. However, these visualization tools do not actually measure out the portion sizes of food. In these systems, a user finds the appropriate cards or pictures or listings on a chart and then makes a reasonable estimation of what that portion would be on the food they want to eat.

A ruler or other measurement tool would only be partially effective because, while it would measure area of the portion of food correctly, it would not easily measure the volume of the portion of food. A ruler can measure lengths of portions, but it is an extra and tedious calculation to reach a volume and thus amount of the portion size of food. This calculation can be done, but not easily and requires too much math on the part of the dieter and too much memorization of volume amounts associated with proper portions.

Pictures only provide a two-dimensional representation of a portion of food. Further, the dieter has to guess how much food should be on the plate because the size of the pictures is generally less than the size of the actual portion of food. Thus a dieter would have to estimate the size of his or her real portion of food based on guessing the relative amount of space the food takes up on the plate in the picture and then extrapolate the correct size of the portion of food on to their real plate.

Portion cards have also been promoted, however, it is difficult to implement because all the foods people eat, or the “deck” of cards would be too large. Also, the two-dimensional nature of a portion card creates the same limitations as does the two dimensions of a picture discussed above. Neither a card of picture can give an accurate representation of volume. Thus, a person would still be required to guess and eyeball their portion of food to correspond with the right portion sizes. There are also foods that do not translate well to put on a portion card, e.g., foods with more difficult volumes to represent like soup and pasta. Finally, part of the logic behind these cards is that people will take them with them when they eat out. This is flaw in thinking because most people are not willing to take a measuring device out in a public restaurant to measure the amount of food on their plates, no matter how unintrusive those tools might be.

Portion control plates are another tool that has been developed, but they are not effective, for various reasons. There are many common foods that have to be portioned out for effective weight loss and maintenance. However, there is no way to put all the different foods people eat on to one plate. There are only so many sections which could be on a plate, and the number of these sections does not reflect the vast variations of food that people eat. For example, creamy soups and other foods eaten in deep volume dishes could not be portioned out with one of these plates. Likewise, salad dressings, and other foods which are used as flavorings on top of other foods, e.g., maple syrup, sauces, olive oil, etc. are all foods that are put on top of other foods and one cannot put them in a section on a portion plate. Further, there is no restriction on how high a person might pile their portion of food even though the plate is divided, thus one of the dimensions to a proper portion of food can't be calculated with a flat portion plate. Volume restrictions of a portion plate limit its effectiveness for portion control or for illustrating the proper portions of many foods.

There are also behavioral and social limitations to using a portion plate. Most people will not eat every meal off of one plate for a long enough time to truly learn portion control. Further, forcing a person to eat off of one plate is psychologically restrictive. While every one else at a meal is eating off of different plates, a person using a diet plate would be socially different. Finally, it is a big jump in nerve synopsis to see the size of a portion of food in a segmented plate and be able to know what that portion size of food will look like on any other plate, on different size plates and on the many different plates which people use in the course of a lifetime.

Other weight control methods use point systems. For example, Weight Watchers developed a formula that generated points for different foods based on the amount of calories in different foods. While it is certainly easier to count and remember 30 points over the course of a day than 2000 calories, it is still a difficult mathematical regimen. First, counting to 30 is still counting and 30 is not a small enough number to be insignificant; it is a lot to remember in one day and it's too complicated for most people to continue to do over a lifetime. Certain types of people are successful on Weight Watchers or people are successful on Weight Watchers for a certain amount of time. To be successful, a participant must be very precise and keep a running tally on numbers throughout the day every day. This is an abnormal behavior for most people when it comes to eating and food. This is not a habit which most people can sustain for a lifetime so a point system reflects the very psychological challenges that counting calories do for many people: it is tedious, it is too regimented for a lifetime, and it leads to too much focus on every piece of food a person eats which is too stressful to continue for a lifetime.

Also, since different points are assigned to different foods, and since different foods have a much larger point value than others, the feelings of guilt and stress naturally occur when someone chooses to eat a high point value food, like a cheeseburger over a salad. And when someone consistently chooses lower point foods rather than the foods they really want to eat, a feeling of deprivation will rapidly occur. Guilt, stress, and deprivation are the emotions that will lead most people to abandon any diet after a short period of time, leading to failure for long term weight loss and maintenance.

The information included in this Background section of the specification, including any references cited herein and any description or discussion thereof, is included for technical reference purposes only and is not to be regarded subject matter by which the scope of the invention is to be bound.

### SUMMARY

A set of volumetric measuring devices or portioning scoops are disclosed for use in a weight loss and weight maintenance program. Each volumetric measuring device is configured to measure a single portion size for any particular food in a respective category of food. Each category of food is associated with one of the measuring devices in the set. Single portion sizes of particular foods are measured by appropriate measuring devices that limit the calorie value of the single portion size of the particular food within a small range. For some foods, a single portion size may be one measured quantity of a measuring device, whereas for other foods a single portion may be two or more measured quantities of the measuring device. Over time (e.g., a week or a month), the calorie intake from foods measured with a particular scoop will average to a desired amount within the parameters of the program. In one implementation, the measuring devices correspond to and are used to measure foods classified in the following categories: carbohydrates, saucy dishes, baked goods, meats, dairy, toppings (e.g., butter and salad dressing), goodies (e.g., snacks and side dishes), and liquids.

A chart may be used in conjunction with the measuring devices to teach and remind the user by depicting the respective categories of food, a listing of particular foods in each category of food, and a number of volumes of each respective measuring device corresponding to the single portion size for each particular food. The measuring devices may be correlated with the categories of foods depicted on the chart, for example by color, letter, number, or symbol coding schemes.

A method for weight loss and weight maintenance using the measuring devices is also disclosed. In one implementation, the method provides a set of food measuring devices, wherein each food measuring device in the set corresponds to a respective category of food. A single portion size is then measured for any particular food in the respective category of food using one of the food measuring devices in the set that limit the calorie value of the single portion size of the particular food within a small range. A number of portions measured by for consumption by a user in a single day is thereby limited. In one implementation, a serving of an additional portion in a single day may be allowed if the user compensates for the additional portion by performing a prescribed amount of exercise. The user is also allowed to consume unlimited amounts of free foods in addition to the limited number of portions. Free foods include fruits, vegetables, low-fat dairy products, and other foods that are low calorie, even at high volume intake.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIG. 1 is an isometric view of an implementation of a set of measuring devices for use in the disclosed portion control system.

FIG. 2 is a front elevation view of the set of measuring devices of FIG. 1.

FIG. 3 is a rear elevation view of the set of measuring devices of FIG. 1.

FIG. 4 is an isometric view of an implementation of a carbohydrate scoop in the set of measuring devices of FIG. 1.

FIG. 5 is a top isometric view of an implementation of a saucy dishes scoop or a toppings scoop in the set of measuring devices of FIG. 1.

FIG. 6 is a bottom isometric view of an implementation of a baked goods scoop in the set of measuring devices of FIG. 1.

FIG. 7 is a top plan view of an implementation of a baked goods scoop in the set of measuring devices of FIG. 1.

FIG. 8 is an isometric view of an implementation of a meats scoop in the set of measuring devices of FIG. 1.

FIG. 9 is a top plan view of an implementation of a meats scoop in the set of measuring devices of FIG. 1.

FIG. 10 is a top isometric view of an implementation of a dairy scoop in the set of measuring devices of FIG. 1.

FIG. 11 is a top isometric view of an implementation of a goodies scoop in the set of measuring devices of FIG. 1.

FIG. 12 is an isometric view of an implementation of a liquids cup in the set of measuring devices of FIG. 1.

FIG. 13 is a chart depicting an implementation of a correlation between food categories and particular foods in each category and each of the measuring devices of FIG. 1.

FIG. 14 is a chart depicting an implementation of food categories and particular foods for consumption in natural portion sizes according to the portion control system.

FIG. 15 is a photograph of a prototype implementation of a set of measuring devices for use in the disclosed portion control system.

FIG. 16 is a schematic diagram of factors used to determine types and sizes of measuring devices for the portion control system.

FIG. 17 is a schematic diagram comparing and contrasting the portion control system with known typical diet systems.

FIG. 18 is a schematic diagram of steps taken by a user to perform the portion control system to achieve weight loss and weight management.

### DETAILED DESCRIPTION

Nutritionists, scientists, and medical experts have all recommended downsizing portions of food consumed in order to promote weight loss. However, no effective tool has ever been provided to assist in determining what a “correct” portion size is. Often patients are told to visualize the right-size portions of food by suggesting an image of an object of similar size or volume to the recommended portion size. However, it is hard to truly visualize the size of an object, e.g., a deck of cards or a golf ball. It is not psychologically easy or pleasing to compare food to some unrelated object. For example, if a person is told that the correct portion of cereal is half a softball, the extrapolation to the correct amount of cereal can be difficult. First, the person has to visualize a softball, then visualize cutting that softball in half, and then, using that three-dimensional image formed in the mind, portion out the correct amount of cereal into a cereal bowl. In addition, a person would have to remember all the visualizations of different objects for all the different foods the person eats, requiring a great deal of memorization or calculation which most people won't do successfully.

In view of these principles, the disclosed portion control system for weigh loss and weight management was developed. This weight loss and weight maintenance system focuses on just 1 concept—reducing the portion sizes of food a person eats. Other weight loss programs make a person cut out certain foods, eat other specific types of foods, cut out foods a person loves, or remove or reduce entire specific categories of foods (e.g., sugars, carbs, fats, etc.) from their diet. These diets ultimately fail because they make a person change too many eating habits at one time. The most important change to weight loss and weight maintenance is reducing portion sizes. If a person focuses on just one habit change that person will find it easier to implement the change. If a person truly eats foods that they love without any psychological stress in terms of their success in losing weight and keeping that weight off, then they will be able to eat smaller portions of food. And if a person eats smaller portions of food—smaller portions than what they are eating now—they will consume fewer calories and thus lose weight.

The portion scoops in this system were designed based upon an objective of allowing a person to eat whatever they want and the only way a person will lose weight on our program is by eating smaller portions of foods. This logic also supported designing portion sizes that factor in all the different foods people eat without restrictions, including foods high in carbs and fats and sugar. This logic also supports the design a family of portion scoops, which assumes that an average person would eat a mix of high carb and high fat foods in a day and in a lifetime and we had to develop portion sizes based on this mix of different foods and calorie counts.

The program is a unique calorie-counting program in that, unlike other calorie counting programs, measures and controls ranges of calories as opposed to exact calorie counts. This is more reflective of how the human body deals with, burns, and absorbs calories. The program also allows a range of calories because, unlike other calorie counting programs, the program is not based on a 24-hour calorie count, but rather a more natural time period of a week or a month in which the body addresses the calories it consumes. This less restrictive timetable allows more freedom of choice in foods for a person and removes the psychological stress of counting calories and maintaining an exact calorie count in a day. he program is thus easier to follow for a lifetime and has greater potential to lead to long term calorie restriction, long term and more permanent weight loss, and weight maintenance.

In contrast to prior systems or programs, the present system includes the use of a set of measuring devices for measuring the appropriate portion sizes of the most commonly consumed foods in an average, normal diet. A portioning tool may clearly illustrate the correct portion sizes of all the different foods a person can eat. A portioning tool removes the need for visualizing, guessing, and eyeballing a correct portion size. The system disclosed herein uses portioning scoops to measure out the proper amount of food on to a plate, which over time leads to weight loss and weight maintenance. The portion scoops in the present system were also designed based on an objective of analysis of calorie ranges and not exact calorie counts. The unique food categories were designed as a result of reliance on calorie ranges and not on exact calorie counts of food consumed on a daily basis.

The volumetric measuring devices are three-dimensional aids to help a person measure the right portion sizes of all the food they eat by size, not by weight. This system addresses more foods than a portion plate can address. Thus, foods like soup and salad dressing can be portioned out with the devices and methods disclosed herein. Using measuring devices to directly dispense the right portion sizes of foods removes any uncertainty and guesswork, which would occur using the visualizations suggested in the media or the 2 dimensional guides given in pictures, cards or charts.

The portioning scoops are all-inclusive with respect to foods that can be portioned. Thus, a person will be free to eat the wide variety of foods he or she might prefer, without any stigma or judgment as to the damage the food might do to his or her diet. This freedom thus takes away the guilt, deprivation, and other stresses a person encounters on most diets and weight loss programs.

Using measuring scoops to portion food out on to a plate provides the flexibility to put the proper portions of food on any plate normally used, and on a variety of plates that might be used. This freedom takes away the social and psychological stigma of eating off of one sectional plate.

By avoiding traditional measurements like ounces or grams, these volumetric measuring devices allow a person to focus on and learn the size of the portions of food they eat and focus on amounts. This knowledge is more effective and allows a user to recognize the correct portion sizes when they can't measure their foods, e.g., in a restaurant or when they are away from the scoops or when they eat food prepared and served by someone else.

The measuring devices also measure specific food categories that are instinctive to a user. Thus, a person can quickly learn the general concepts of the size of portions they should eat (e.g., the size of meat portions or pasta portions) to realize an effective weight loss and weight loss maintenance program.

Portioning out food is similar to measuring out food in following a recipe, which is a habit many people already have or understand. Therefore, there is a minimal amount of learning involved or changes in normal behavior. In addition, there is no new habit to learn, thus making this weight loss process an easier one to incorporate in a daily routine and follow for the rest of a lifetime.

The food category names used in the disclosed system that are measured by an individual portion scoop are placed on the scooper rather than measurements like grams and ounces. It is much simpler to merely fill and dispense a scoop onto a plate than measuring the proper portions of foods using grams or ounces or liters or quarts or other traditional weight and volume numbers. Therefore, it makes the portioning process for weight loss and weight loss maintenance much easier. In using traditional weight and volume measurements with measuring devices, a person would have to not only portion the food with the measuring device, but also have to know or look up what the appropriate measurement is (e.g., in ounces or grams) to dispense an appropriate portion size for weight loss. This is a two-step process involving calculation of weights or volumes.

By putting the names of the food categories on the portioning scoops, portioning out food for weight loss and weight loss maintenance transforms from a 2 or more step process to a much easier 1-step process. A person no longer has to remember weights or volumes nor perform more complicated calculations. With our portioning devices a person only has to match the type of food with the name of the food on the measuring device and get the right portion of food for the purpose of weight loss and weight loss maintenance. Thus, in contrast to the traditional 2-step portioning process, this 1-step portioning process involves less memorization, less tedious measuring, less chance of mistake, and greater chance that a person will incorporate this simple portion measuring process into their lives when preparing their food to eat.

Some diets use standard measuring devices during the food preparation process to guide people towards the proper amount of foods they should eat. For example, some diets provide recipes which suggest specific raw food quantities that, once prepared according to the recipe, will result in a certain number of servings. Measuring devices used in this way portion out uncooked food, and push a person to cook the dish in a specific way. The portioning scoops and system disclosed herein measure out previously prepared and cooked foods. This portioning method does not intrude in the process of cooking food. Thus, a person can use their favorite recipes to prepare their foods without concern for weight loss and weight loss maintenance. The system discipline is to portion the food on to the plate after it is prepared but before eating. The portion scoops disclosed herein were designed to measure out the calories of already cooked or prepared food without altering or changing favorite foods or the eating experience. Thus, if a person can eat the food they love in the way they love it, but still eat a portion size that elicits weight loss or weight loss maintenance, the person won't feel deprived or guilty, and will more likely continue this process for a lifetime.

The portioning scoops disclosed herein were designed to measure out portion sizes with the intent of losing weight and maintaining that weight loss while still eating a range of foods that may be prepared and cooked in different ways. The portion sizes measured by the scoops factor in a range of calories that occur by the different ways of preparing even the same food. Thus, for example, the portion sizes of the portion scoops realize weight loss and weight maintenance regardless of whether a piece of grilled chicken or breaded chicken or chicken parmesan is served. The difference in calories between those different dishes served in the portion sizes of this program is insignificant in terms of weight loss and weight loss maintenance, but beneficial in allowing a person to eat the foods they want in the way they want them for total satisfaction.

Further, the scoops are color coded to match a wall chart which more specifically and accurately gives the right portion sizes of food based on the measuring devices and how many scoops a person can have to measure out one portion. This family of color-coded measuring devices with the names of food categories on them help to reinforce the measurements of foods which are divided into the same food categories on the wall chart but are \not easy to measure in our portion scoopers. Thus, a person using these measuring devices to measure categories families of food will find it easier to learn the proper portions of all food, even those not measured by these scoopers.

The measuring devices eliminate the need for extrapolated visualization and comparison to imagined objects or merely guessing. For example, by using an appropriately-sized carbohydrate measuring device, a user can dispense an appropriately sized cereal breakfast by filling the measuring device with the cereal and placing that quantity into a bowl. There is no further need for extrapolated visualization and the correct portion of cereal is dispensed every time.

Measuring out food in the measuring devices of the disclosed system, rather than trying to visualize food portions as compared to other objects, allows a user to visualize the right quantities of food in the context of the user's own dishes. After a short period of time, e.g., a few weeks, the user will start to remember how these portion sizes appear in their own bowl or on their own plate, i.e., directly visualize the correct portion size, and may not need to use the measuring devices in the future for commonly consumed types of food. For example, after a few weeks of use a user may be able to merely look at their bowl of cereal and remember what the right portion of cereal looks like in their cereal bowl or what the appropriate portions of fish and pasta looks like on their plate.

Eventually a user may be able to look at a plate and recognize when there is too much food on it and directly visualize the right portions of food for weight loss and weight maintenance. However, it is only after a user performs the physical activity of consistently measuring out the proper portions of food onto a plate \and seeing what that amount of food looks like on a plate, and then eating the proper portions of food—meal after meal and day after day for several weeks or months—that the user will be able to visualize the correct portions of food when sitting down to eat at home or even when out at a restaurant.

In addition, by eating the right portion sizes of foods for several weeks, a person will then begin to sense the right portion sizes and his or her body will start to register the sensation of being “full’ after eating the right portion of food which is a smaller portion of food than they are most likely eating before starting the program.

The volumes of the portioning scoops were designed to handle the range of calories of the different foods that people would measure with each portion scooper. The system was developed around a family of scoopers and corresponding food portions that reflects how people eat and provides portions that leave users satisfied at a meal, but still small enough to lose weight and to keep it off. The system thereby also provides psychological satisfaction so that users do not feel deprived, hungry, or guilty.

The system is not as simple as putting all the meat in one scoop and all fats or all carbs in another. For example, how should meat that comes in sauces? That dish should not go into the same scoop that grilled meat goes into because of the fat and additional calories in the sauces. As another example, how should carbohydrates that are sweets as opposed to pastas and/or rice be treated? The calorie counts are very different for different portion sizes of these foods even though they are all carbohydrates. Plus, people tend to eat pastas and rice with a meal and sweets for desserts or snacks which also lend themselves to different portion sizes. What about cheeses versus butter? Butter is often used as a flavoring which suggests that less butter is needed to enhance the eating experience. Plus butter has much more calories and fat in it than a comparable size of most cheeses.

The system factors in the calorie count and the way people eat these foods to come up with categories of foods, a corresponding family of scoops, and a portioning system which makes sense, is easy to use, and leads to weight loss and weight loss maintenance. To accomplish these ends and to cover all the foods that Americans eat, unique food categories were created for this system to keep the system manageable and to cluster lots of different foods together in a particular category.

Therefore, the portion scoopers and food categories were designed beyond the traditional protein, carbohydrate, and fat separations to keep the number of portion scoopers to a small enough number as to be manageable and workable, but large enough to cover all the foods that people eat. All the possible foods eaten were broken into a small number of categories to make it easier for a user to learn and remember the portion sizes. The foods in each category have a similar portion size. Thus, all the foods in each category can be measured in the corresponding measuring device. The weight loss and weight maintenance system is thus based on portion scoopers which measure out portion sizes of food that users can easily learn to use and that will realize weight loss and lifetime weight maintenance.

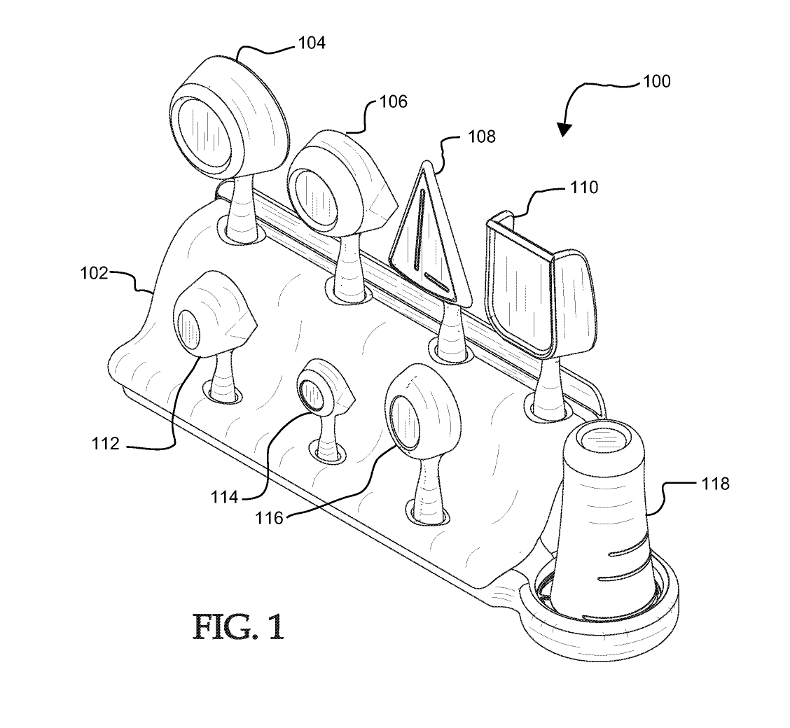

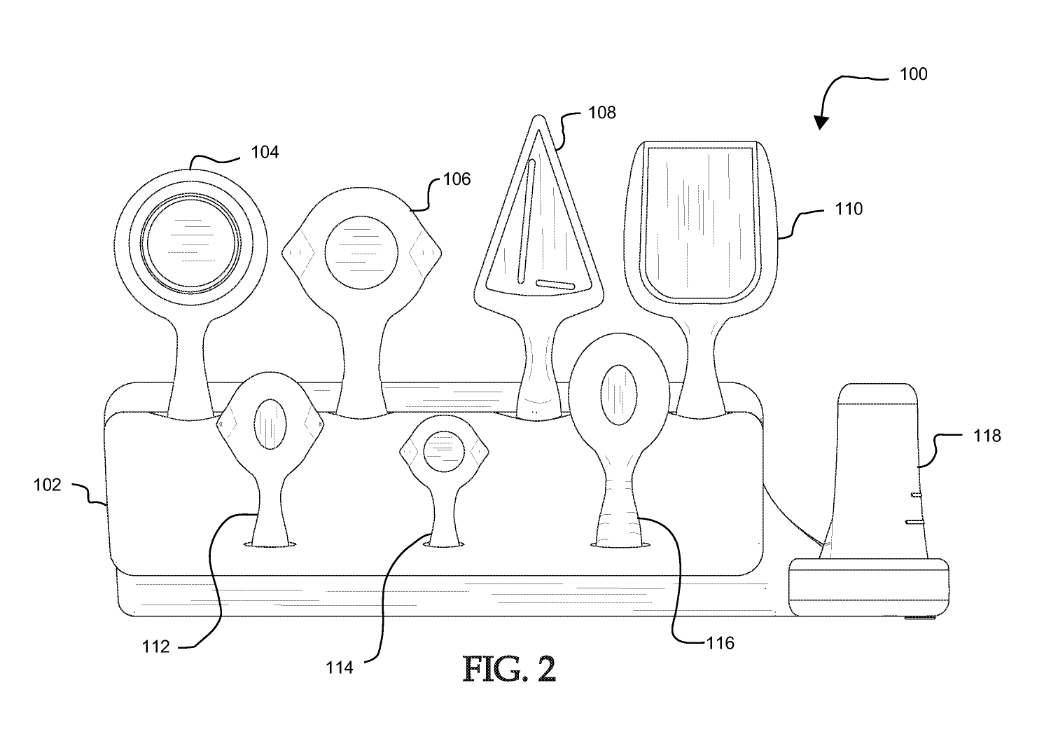

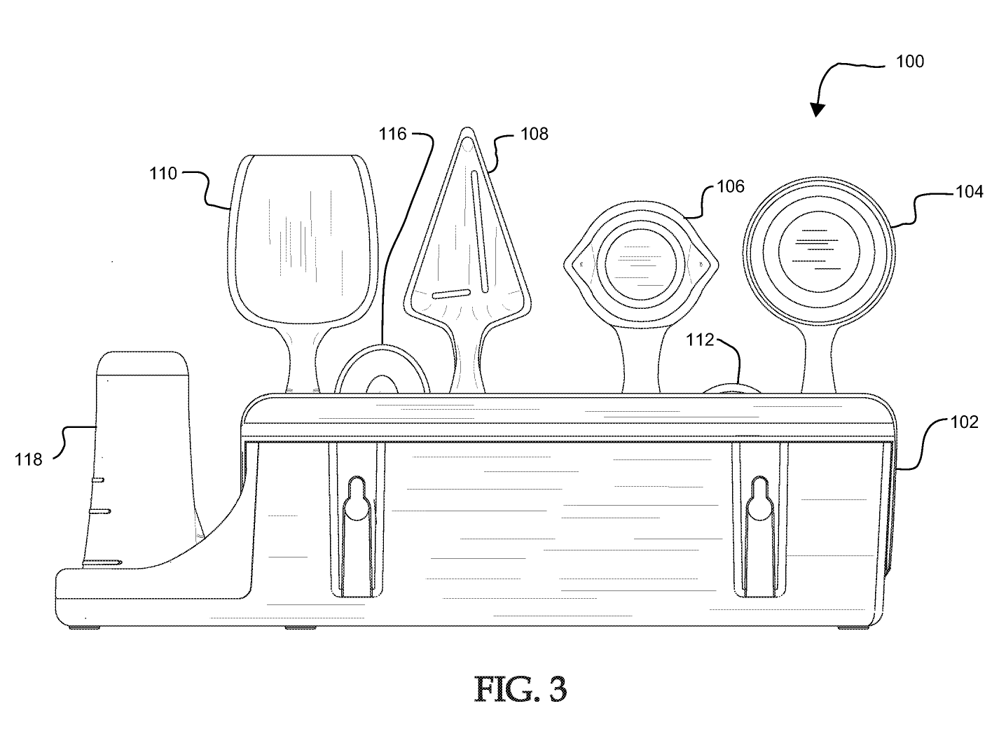

FIGS. 1-3 and 15 depict an exemplary set of measuring devices 100 for controlling the portion sizes of different types of foods. The measuring devices 100 may be stored in a base unit 102 for ease of storage and identification of purpose. In one implementation a selection of measuring devices may include a carbohydrate scoop 104, a saucy dish scoop 106, a baked goods scoop 108, a meat scoop 110, a dairy scoop 112, a toppings scoop 114, a goodies scoop 116, and a liquids cup 118. Each of the measuring devices is clearly labeled and color-coded for ease of use and for reference to a corresponding portion chart indicating the number of scoops per portion for a particular type of food as further described below.

The measuring devices 100 are three-dimensional tools designed to help measure the amount of food a user should eat by size or volume, not by weight. Instead of measuring ounces or grams or tablespoons, these measuring devices 100 measure the proper portion sizes of the following major food types:

Carbohydrates, e.g., pastas, potatoes, rice, etc.

Saucy Dishes, e.g., stews, spaghetti and meat sauce, take-out Chinese, etc.

Baked Goods, e.g., cake and pie wedge

Meats, e.g., beef, poultry, pork, and fish;

Dairy, e.g., cheeses, ice cream, creamy sauces and soups, etc.

Toppings, e.g., dressings, sauces, butter, etc.

Goodies, e.g., snacks, chips, dips, sides (cole slaw, potato salad), etc., and

Liquids, e.g., milk, juice, and soda.

These food categories were based upon a theory that effective weight loss and weight maintenance for the great majority of people can only be accomplished by reducing the amount of calories consumed and further by lowering the amount of calories consumed in contrast to the amount of calories used by the body—the irrefutable scientific equation of calories in versus calories out. However, these food categories were based on our unique belief that effective calorie reduction cannot be done to an exact number by most individuals. Counting calories is too difficult for most people since one can't actually see a calorie. Further, exact calorie counting is an unnatural behavior and so stressful in eating and choosing the foods to eat that it creates nervouseness, guilt and eventually deprivation in most people attempting to count calories. This eventually drives a people to leave weight loss programs.

It is theorized that the body does not burn or address the calories consumed in an exact calorie number nor on an exact 24 hour basis, but rather in a range of calories over the course of a week or a month. Therefore, most effective weight loss and weight loss maintenance can be accomplished by reducing caloric intake with a range, not to an exact number. A range of calories deemed effective for weight loss and weight maintenance was then determined. Relying on reducing caloric consumption by a range rather than by an exact number provided the ability to group several foods together in similar portion sizes. With this backdrop, the program presents 9 categories of foods—the eight mentioned above which have corresponding measuring devices and a category of free foods, which are foods that are so low in caloric content that a large quantity can be consumed without consuming a lot of calories. Thus, a person on the program may eat as much of these free foods that he or she may want without having to portion them. These categories of food are small enough in number to make the complete program and portioning system easy to follow and thus more likely for a person to maintain for the rest of his or her life. These categories of food are also very intuitive so they become very easy to learn.

By grouping different foods together in specific categories allows a person more freedom of choice in eating with the intent of weight loss and weight loss maintenance, and thus takes away much of the psychological stress, guilt, and deprivation caused by other more numerically stringent weight loss programs. For example, all meats are portioned out in the same portion scooper and to the same portion size in the instant program. The portion of steak at this portion size will have about 150 more calories than the portion of chicken at this portion size. On other more stringent weight loss programs, that 150 calorie difference would be so significant as to force a person to choose the chicken and thus eventually cause the person to feel deprived by not eating steak when he or she wants, and guilty when the person eventually eats some steak. These psychological stresses are major factors causing people to only stay on a diet for a short time. By dealing with cutting calories by a range and by portion sizes, a person on the instant program would portion out their meat serving with the meat portioning scoop and would not feel penalized by choosing steak over chicken if they desired steak. This freedom to choose any food avoids the psychological stresses of guilt and deprivation.

It is theorized that eating an extra 150 calories one day will be counterbalanced by the fact that a person will be more likely to stay on a reduced calorie and portion size plan for a lifetime since they are not asked to sacrifice or eliminate any foods they love. So over the course of time and in the long run, a person will cut more calories in a week or month in the instant program than over the course of a lifetime when a person makes more extreme cuts in calories and foods eaten for short spurts of time. These food categories have been created and the measuring devices have been designed to support the range of calories determined to be effective for weight loss and weight loss maintenance in most people. Addressing calorie reduction as a range allowed the creation of intuitive categories of food that are logical and thus easy to remember for the user.

Some categories are familiar, for example, meats, carbohydrates, dairy, and liquids. These are categories of foods that generally have similar portion sizes. For example, the proper portion of a piece of steak is similar to the proper portion of a piece of chicken or fish. The proper portion of BBQ sauce is similar to the proper portion of salad dressing.

Another basis for categorization is treatment of foods that are eaten in similar ways. For example, people tend to drink liquids the same way. Toppings are foods usually put on top of other foods, e.g., butter and jellies. Goodies are foods we usually eat as snacks or appetizers.

Another basis for categorization is foods that look similar. For example, liquids look similar to each other, but so do saucy dishes. These are foods that tend to be a mix of meats and vegetables in a rather heavy sauce, like Chinese food and stews. Baked goods are made up of pies and cakes and muffins, which tend to look more like each other than other possible dessert foods such as cookies or ice cream. Eggs, for example, aren't a meat, but they aren't dairy either. In the present system, they are categorized as meat because of the way they are eaten as a main protein source at a meal. As another example, butter is a dairy food, but it is placed in toppings, because butter is placed on top of foods and also because an appropriate portion of butter from a calorie perspective needs to be smaller than if it were measured with the dairy container.

Some foods are not portioned with measuring devices in the disclosed system, but are instead considered “free” as further described below. All fruits and all vegetables and most low-fat dairy are considered free foods in the present system. A user can eat as much free food as desired under the system and they need not be portioned. Free foods are determined by the logic that one can eat large quantities of these foods and fill up on them without ingesting large amounts of calories.

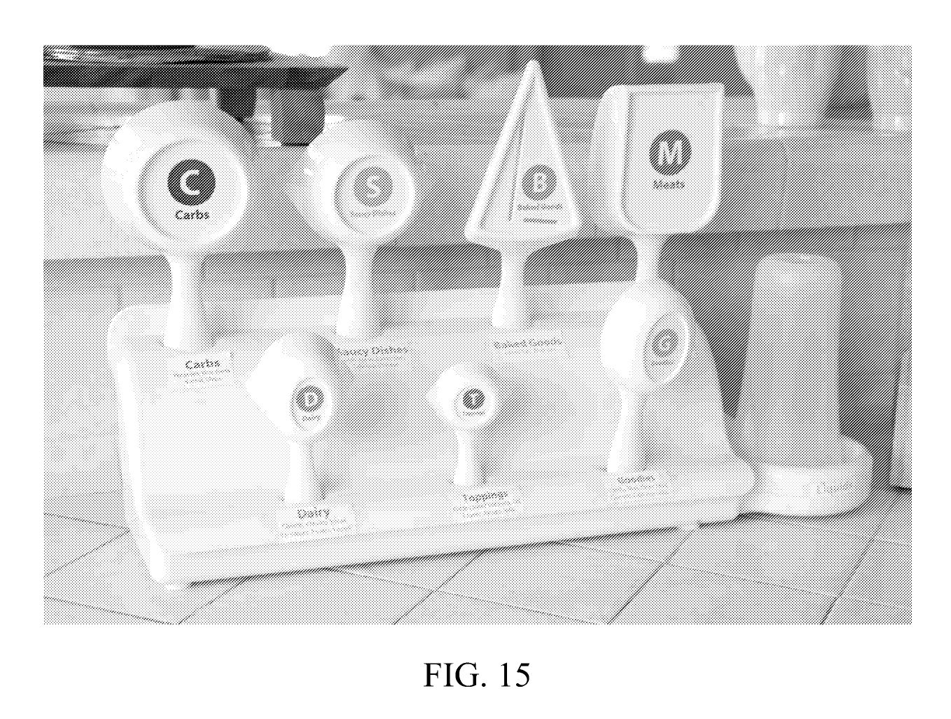

As shown in FIG. 15, the measuring devices 100 may be made out of any appropriate material, for example, plastic, resin, tempered glass, metal, wood, or other material capable of being formed into the desired shapes. In one implementation, the measuring devices may be moulded out of a thermoset polymer with high heat resistant characteristics resulting in a dishwasher and microwave safe product that may be easily cleaned and maintained by the user. Such thermoset polymers may also be easily moulded to incorporate identification or directional information. Some thermoset polymers may also be receptive to color printing processes to similarly provide such identification or directional information. In the exemplary embodiment of FIG. 15, the measuring devices are each printed with large, colored labels, (i.e., “C” for carbohydrates, “S” for saucy dishes, “B” for baked goods, “M” for meats, “D” for dairy, “T” for toppings, “G” for goodies, and “L” for liquids) and moulded with recessed bottoms where printed to help protect the labels from scratching off. Such plastics are also receptive to application of adhesive labels for identification and directional information, for example, as shown in the form of labels on the base unit 102 in FIG. 15 indicating the proper storage location for each of the measuring devices. When stored in the base unit, the bottoms of the measuring devices are oriented to face outward to allow for ease of selection by a user.

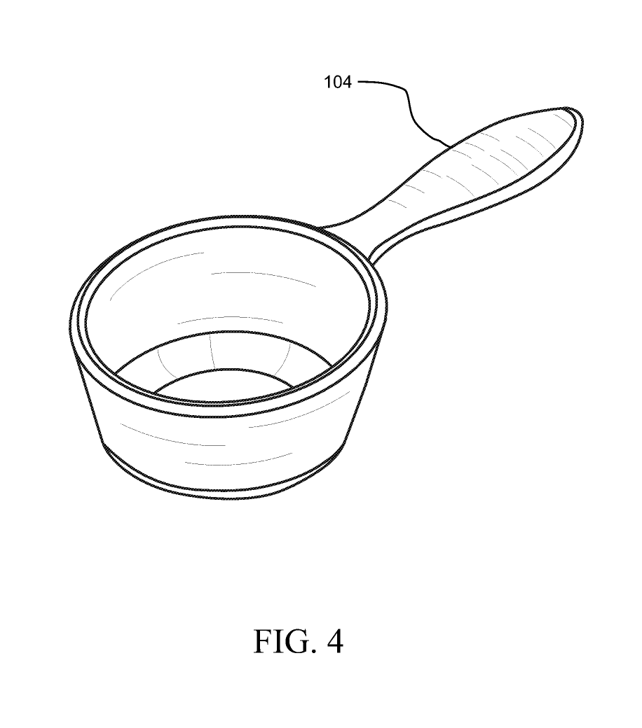

Each measuring device is designed in a shape based on the way a person would use the device to measure their food or how they would put the food in the device. The measuring device design is also based upon the simplest and most logical ways that a person would hold the device, put food in the device, and use it to measure. For example, the carbohydrate scoop 104 is shown in greater detail in FIG. 4 and is used to measure carbohydrate-heavy foods as described above. Many of these foods, e.g., pasta, rice, and potatoes, are often cooked by boiling in water in a pot. In this exemplary embodiment, the bowl-shaped area of the carbohydrate scoop 104 is slightly slanted downward toward the front edge resulting in the back portion of the carbohydrate scoop 104 adjacent the handle being deeper than the front portion where the rim slants down. This makes it ergonomically easier to scoop various carbohydrate-heavy foods out of a pot with the carbohydrate scoop 104. Alternatively, the carbohydrate scoop 104 may be held by the handle with one hand and is large enough for a user to use a serving spoon or ladle with the other hand to fill the carbohydrate scoop 104.

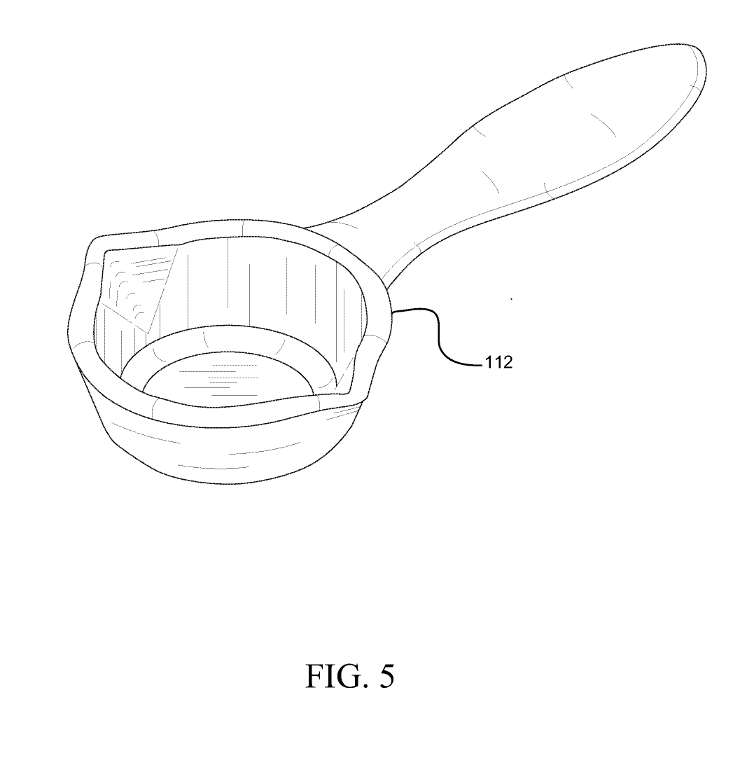

The saucy dishes scoop 106 is shown in greater detail in FIG. 5. In this exemplary embodiment, the saucy dishes scoop 106 is formed similar to a ladle with spouts on lateral sides of the bowl-shaped area with respect to the axis of the handle. The spouts allow for easy pouring of dishes like stews and Chinese take-out dishes while minimizing splatter and mess that might occur without a spout.

The toppings scoop 114 is identical in form to the saucy dishes scoop 106 in this exemplary implementation and is merely smaller in size and thus provides a smaller volume portion for toppings. The toppings scoop 114 is small in order to control the amount of butter used. Other foods measured in this device, e.g., salad dressing, maple syrup, and BBQ sauce uses two helpings of this device to make up one portion. Because controlling butter is important, the container is the size of one portion of butter rather than instructing users to use ½ a toppings scoop 104 for the portion of butter.

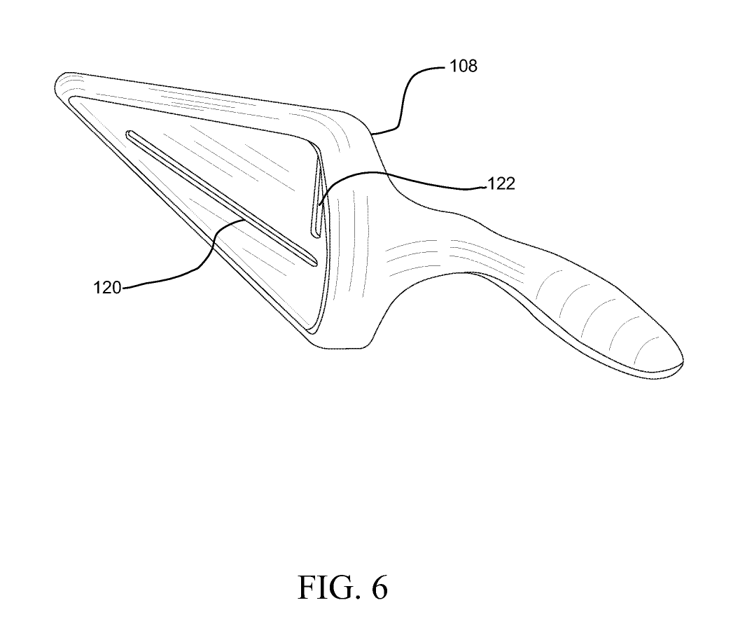

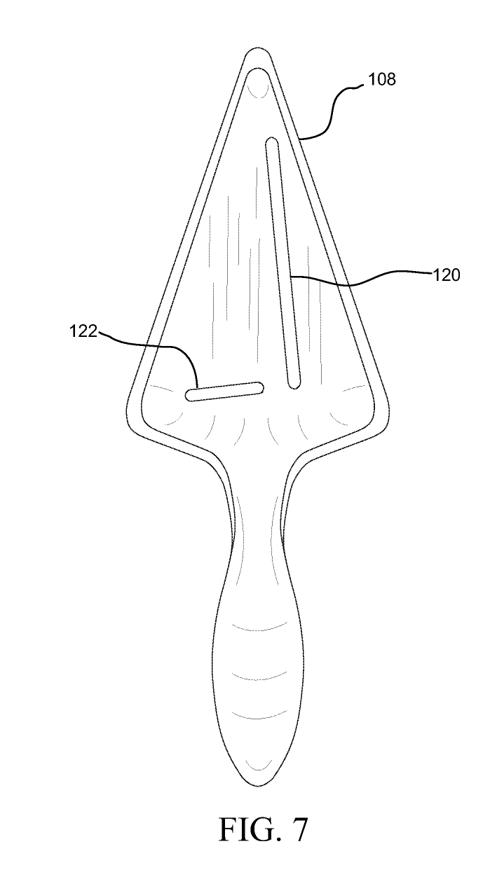

The baked goods scoop 108 is shown in greater detail in FIGS. 6 and 7. In this exemplary embodiment, the baked goods scoop 108 is formed similar in shape to a pie server. This allows the baked goods scoop 108 to act as a serving utensil for foods like pies and cakes. The baked goods scoop 108 is marked with two slots 120, 122 arranged generally orthogonal to each other to form a smaller triangle within the larger triangle shape of the serving end of the baked goods scoop 108. This smaller triangle area may be used to measure a smaller portion size for baked goods of greater depth, e.g., a layer cake or a cheesecake, while the larger area may be used to measure goods of smaller depth, e.g., a pie or a cobbler, in order to maintain consistency in portion sizes between various forms of baked goods.

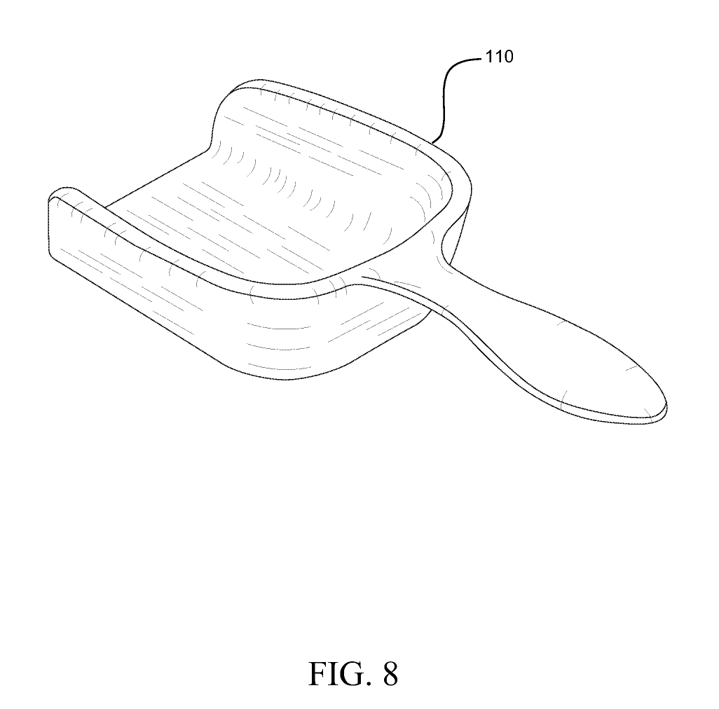

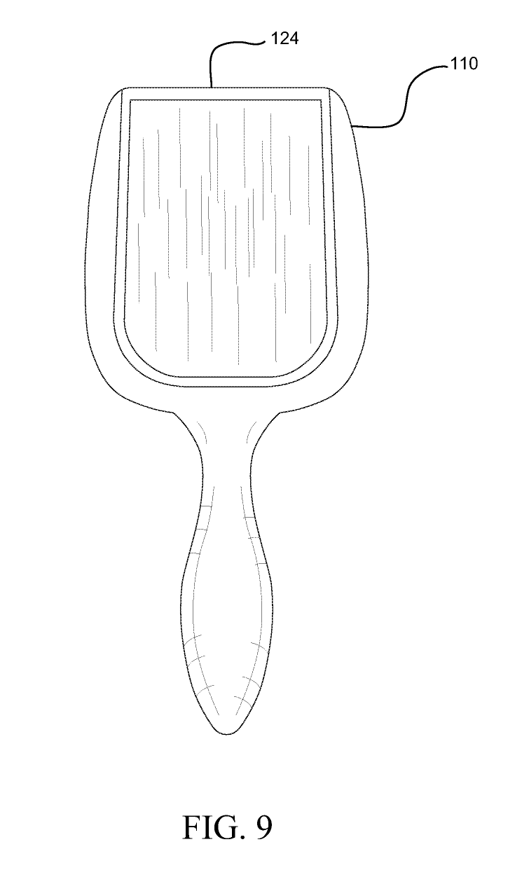

The meat scoop 110 is shown in greater detail in FIGS. 8 and 9. In this exemplary embodiment, the meat scoop 110 is formed of three sides with an open end and a generally rectangular well as most cuts of meat are more rectangular in shape. A defined edge 124 may be formed along the edge of the open end of the meat scoop 110 and was designed to aid the user in cutting a piece of meat to an appropriate size to fit within the meat scoop 110 and therefore conform to an appropriate portion size. Alternately, a user may place a piece of meat in the meat scoop 110 and cut any excess hanging beyond the open end with a knife to serve the proper portion.

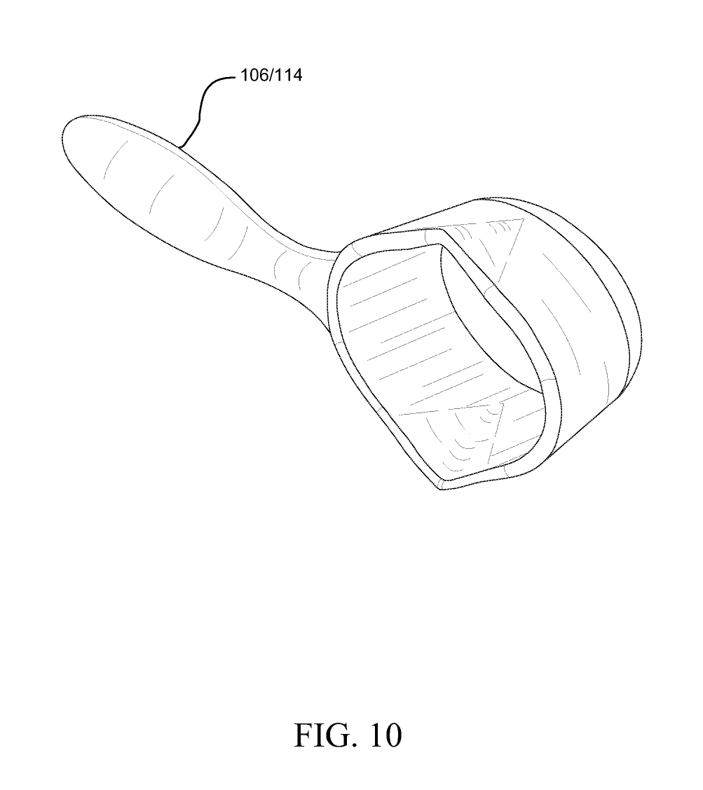

The dairy scoop 112 is shown in greater detail in FIG. 10. In this exemplary embodiment, the dairy scoop 112 is formed in a similar manner to the saucy dishes scoop 106 and the toppings scoop 114 with lateral pour spouts on the rim. However, the dairy scoop 112 is deeper in profile than either of those scoops and narrower in diameter to allow for easier access to typical dairy cartons, e.g., sour cream tubs, and to further accommodate slices of hard cheese from typically sized cheese blocks or a scoop of ice cream.

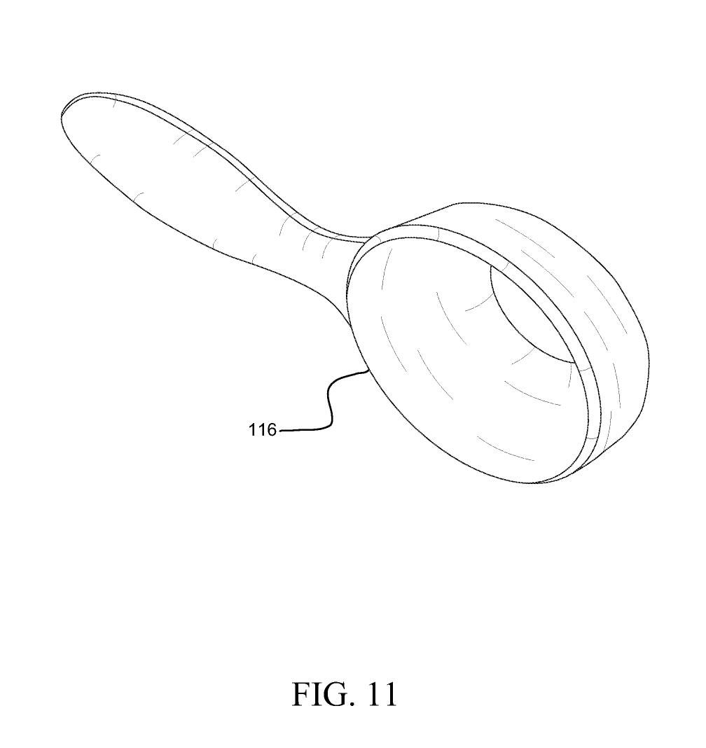

The goodies scoop 116 is shown in greater detail in FIG. 11. In this exemplary embodiment, the goodies scoop 116 is formed as a rounded scoop without spouts like some of the other scoops. This design is intended to make the goodies scoop 116 easy to use with respect to a variety of different types of food that fall within the goodies category, e.g., small candies (M&Ms) and thicker dips (guacamole).

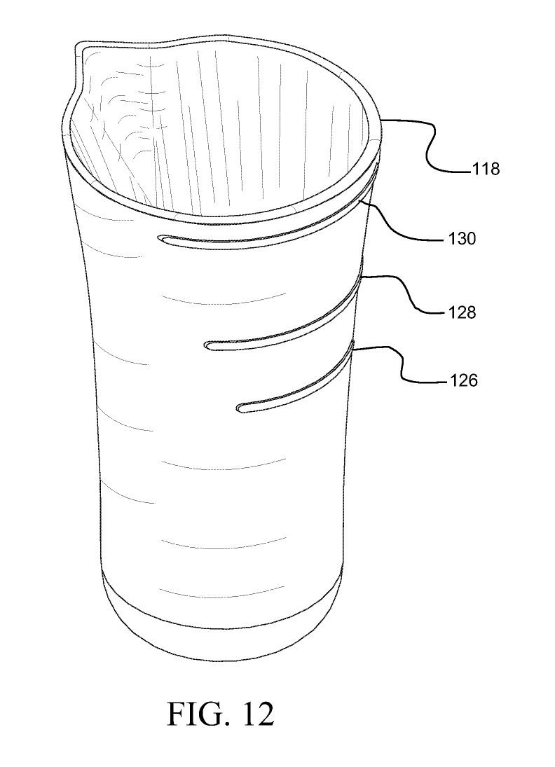

The liquids cup 118 is shown in greater detail in FIG. 12. In this exemplary embodiment, the liquids cup 118 is formed as a drinking cup or glass such that the user can drink a liquid portion directly from the liquids cup 118. However, the rim of the liquids cup 118 is also formed with a spout to allow a liquid portion dispensed within the liquids cup to be easily transferred to another cup or glass without spilling. The liquids cup 118 may be formed of a transparent or semi-transparent material to allow a user to see the level of the fluid dispensed within the liquids cup 118. One or more volume level indicators may be provided on the sidewall of the liquids cup 118 to indicate the appropriate portions for various types of liquids. For example, in the implementation shown in FIG. 12, portions for soda, juice, and milk are labeled on the side of the liquids cup 118 as horizontal lines 126, 128, 130 moulded in relief. Actual textual labels may also be moulded into or printed on the sidewall of the liquids cup 118 to further aid the user in determining the appropriate portion size for a desired liquid.

It should be recognized that the various measuring devices 100 may be designed to take on different form factors to assist the user in portioning different types of foods (e.g., as a device for burritos for the Hispanic and youth markets). Additionally, it may be possible to design additional measuring devices for other categories or subcategories of food types. However, the type and number of measuring devices in the implementation described above has been designed to encompass as many different foods as possible in a reasonable number of easily differentiated categories that lend to similar portion sizes (or scaled portion sizes) for the various foods placed in a particular category.

With names like “Meats” and “Dairy” and “Saucy Dishes,” the measuring devices 100 are very intuitive. For example, all types of meat are always portioned using one meat scoop 106 regardless of the type of meat and even though the fat, calorie, and protein amounts may vary between different types of meat for the same portion size. Similarly, most snacks are portioned out using one goodies scoop 114 regardless of the relative calorie or fat content as between different types of snacks. As another example, spaghetti and meatballs or meat sauce would be measured together in the carbohydrate container because that is how the dish is normally served and eaten. The categories were chosen to follow natural relationships between typical dishes or servings and the measuring devices. This also allows the user to develop an intuition as to which measuring device a “type” of food will go in, even if not explicitly listed in the chart. For example, a user may come to understand that any type of creamy salad (e.g., made with mayonnaise) should be portioned using the “Sides” measuring device. Further, some foods should be portioned in natural units (e.g., slices of bread) as it would be unnatural to serve them in a measuring device. Over time, the user should be able to visualize appropriate portion sizes for any type of food and should even be able to eat in a restaurant without taking the measuring devices to portion the servings.

These portion sizes were also designed to factor in the disparity of different foods measured to the same portion sizes. For example, the meats device was designed to provide someone with a reasonable portion of meat that won't leave him or her hungry or psychologically feeling that the size of their portion of meat was too small (as opposed to a diet). In order to keep the program simple, the meats portion size was chosen so the caloric difference between a portion of steak versus a portion of chicken will only vary by about 150 calories. As a program that is based on calories in versus calories out, 150 calories is not insignificant in a day. However, the program is designed to balance calories over the course of a week or more, not a single day. Thus, even if someone eats a few more calories one day by eating steak instead of chicken, they won't feel deprived by not eating the steak, and therefore not feel as if they are on a diet because they can eat whatever they want. By taking away feelings of deprivation, a person is more likely to follow this program for life. In other words, the goal is to cut the caloric intake every day, but rather than count specific calories every day, it is more important to be flexible within a reasonable range so that someone will feel less restricted and stay with the program for life. The portions in the present system do not cut the same amount of calories every day as a person is free to make their own choices about what to eat. There will be days that people eat more calories and days when they eat less, so it will all work itself out by the end of the week or the month as people make more natural choices. However, if someone is overweight, then the portions will cut their caloric intake every day so they will lose weight.

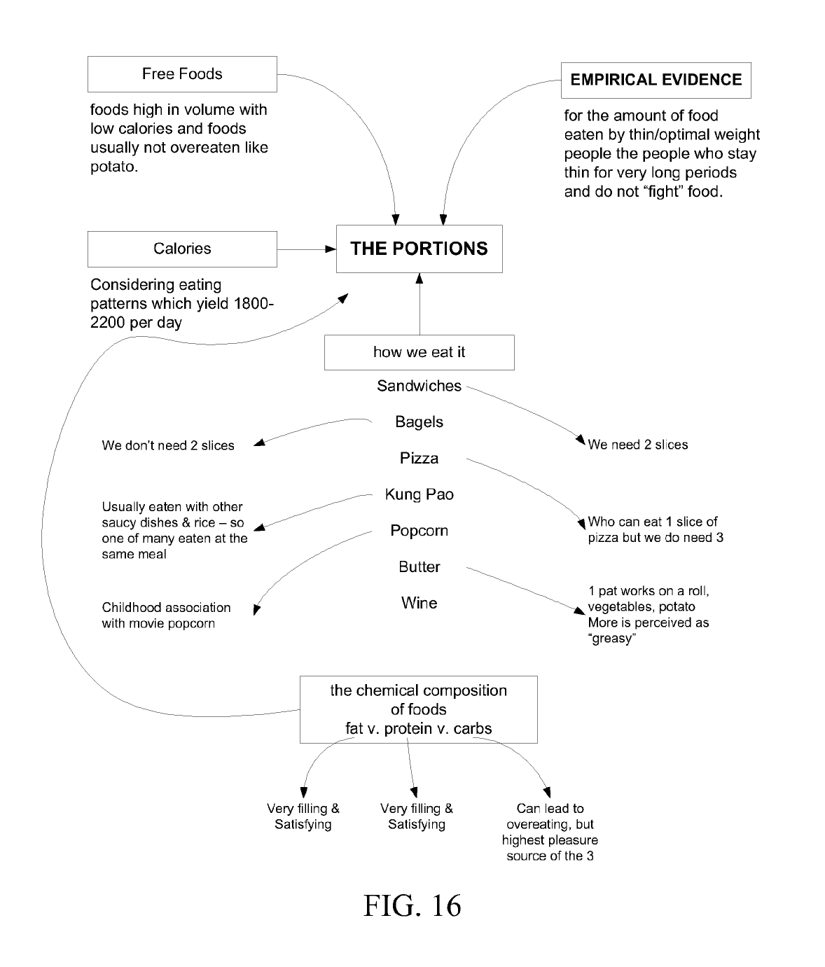

As represented in FIG. 16, in designing the portion sizes for the measuring devices 100, an analysis of the major different types of food normally eaten in a meal and in a day for a particular diet, the relative portions eaten by an average person of the particular diet, and the calories in the amount of these types of food in each of the portions was conducted. This information was then extrapolated to determine the types, number, and sizes of the measuring devices for a particular ethnic that would allow a person to eat familiar foods at a portion size that will leave a person satisfied, but at a calorie level that will both result in weight loss for those overweight and maintain a healthy weight once that weight is achieved.

For the implementation of measuring devices 100 depicted in FIGS. 1-12, an estimate of what an average reasonable person eats in America was developed, i.e., what specific foods are eaten for breakfast, lunch, dinner, snacks, and dessert. Then sample menus of an average day, an average week, and an average month using these foods were developed to calculate a calorie count that would lead to weight loss. The portion sizes of the different foods were then determined that are generally representative of that calorie count. An exemplary collection of sample menus for a five day period are presented in Table 1 below.

TABLE 1

| | Day 1 | Day 2 | Day 3 | Day 4 | Day 5 |
|---|---|---|---|---|---|
| | Egg | Bagel | Cereal | Waffles | Egg McMuffin |
| | Sausages | Cream | Milk | Butter | Hash Browns |
| | Coffee | Cheese | Juice | Maple Syrup | OJ |
| Calorie | 400 | 300 | 400 | 375 | 750 |
| Count | | | | | |
| | Turkey | Cheese | Pizza | Lasagna | Chili |
| | Swiss | Burger | Coke | Salad | Salad |
| | cheese | Fries | | Dressing | |
| | Bread | Coke | | | |
| | Chips | | | | |
| | Coke | | | | |
| Calorie | 750 | 950 | 750 | 550 | 300 |
| Count | | | | | |
| | Mac and | Take- | Steak | Fried | Spaghetti |
| | Cheese | out | Salad | Chicken | and |
| | Salad | Chinese | Dressing | Mashed | meatballs |
| | Dressing | Rice | Wine | Potatoes | wine |
| Calorie | 500 | 750 | 750 | 750 | 700 |
| Count | | | | | |
| Total | 1700 | 2000 | 1900 | 1675 | 1750 |
| Calorie | | | | | |

This presents a worst-case scenario menu of a person eating really poorly (e.g., high calorie foods like fried chicken) and eating very rich foods (e.g., macaroni and cheese). However, these are the calories for the portions of these foods dispensed using the measuring devices 100 of the described implementation. This menu closely follows the recommended program of limiting food intake to 6 measured portions a day as further explained and described below, but sometimes going over and having 7 portions as it is expected that users will mistakenly do. This menu does not account for those foods designated as “free foods” (e.g., all fruits and vegetables) under the program as further described below or a snack or dessert that a program user may have once a day in addition. While foods like fruits and vegetables are relatively low in calories for the amount of food eaten, the total caloric count for any day would be 50 to several hundred calories more per day. The menu also does not account for a snack or dessert that a program user may have once a day in addition. A snack or dessert portioned using the goodies scoop 116 or the baked goods scoop 108 is considered to be around 150 to 300 calories. Thus, the total extra calories from free foods and a snack or dessert amount to about 200-400 calories per day. This menu also presumes that the user does not exercise during the day. If the user does exercise at an appropriate level, the net caloric intake for a day may be less, or it could be about the same if the user decides to offset the calories burned through exercise with an additional portion, snack, or dessert.

When these total calorie counts for a day are combined with additional calories for a snack and/or dessert plus a typical amount of free foods on that particular day the total daily calorie intake for this exemplary 5 day period is shown below in Table 2.

TABLE 2

| Calorie | | | | | |
|---|---|---|---|---|---|
| Count | Day 1 | Day 2 | Day 3 | Day 4 | Day 5 |
| Total | 1700 | 2000 | 1900 | 1675 | 1750 |
| Calorie | +200-400 | +200-400 | +200-400 | +200-400 | +200-400 |
| Count | 1900-2100 | 2200-2400 | 2100-2300 | 1875-2075 | 1950-2150 |

As indicated in the total calorie counts in Table 2, the caloric intake of a user of the measuring devices 100 pursuant to the weight loss and maintenance program described herein will vary from day to day because the calories of various foods portioned using the same measuring device will vary. However, the portion sizes regimented by the measuring devices 100 ensure that the calorie intake is generally low and that is variable within a range that, while allowing a user to have the freedom to eat whatever desired, will lead to weight loss for overweight users and maintain an appropriate weight if the user reaches a stable healthy weight.

The program is affected by cultural considerations and may be modified to address the dietary habits of different ethnicities. For example, some Asian cultures eat significantly more rice and other carbohydrates, fish, and soy protein than Western cultures. Hispanic diets tend to have more fat. Thus, the types and sizes of scoops in a utensil set for a particular Asian ethnicity may be modified from that shown in the implementation of FIGS. 1-12 and 15

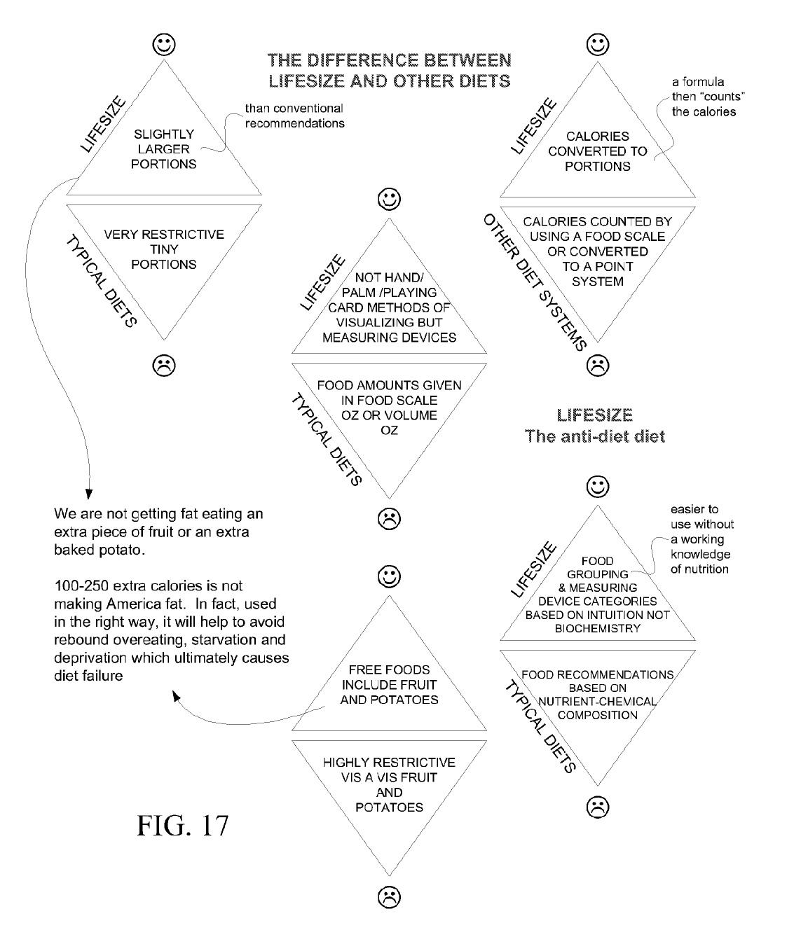

As represented in FIG. 17, the measuring devices are also unique because psychological factors were also considered in designing the portion sizes. For example, consideration was given to how much of a food a person needs to eat to enjoy it—a thimble-size piece of chocolate is not going to be satisfying for most people; however, eating an entire package of candy is too much. Alternatively, half a candy bar should be completely satisfying and is a portion size that could be eaten every day if desired, within the limits of the system for overall portion intake, while still achieving weight loss. In another example, a person might feel that 1 slice of pizza for a meal is too restrictive, while 2 slices of pizza is not only a little more normal but also totally satisfying when a salad or other fee food is added to that meal. This psychological factor in our portion sizes helps prevent a person from feeling deprived, stressed, or hungry, the exact opposite of most diets and diet portion sizes.

As another example, it may be asked what the difference is between a side of potato salad and a side of French fried potatoes? Ultimately, the answer lies in how typical people eat these foods. The portion sizes of the measuring devices were designed to reflect a balance between calories and how the average reasonable person eats different foods. In this example, a portion of potato salad measured out with the carbohydrate scoop 104 would generally be considered too big, and a portion of French fries measured out with the goodies scoop 116 would generally be considered too small. Such a small portion of French fries would not be psychologically satisfying to the typical user.

Convenience and normal eating conditions were also factored into determining the portion sizes for the measuring utensils. (See FIG. 16.) For example, a portion of sliced bread is 2 slices, not 1 slice, so that a user can make a sandwich. Similarly, the portion size of soda is 12 ounces, not 10, because soda comes in 12-ounce cans. It is unrealistic and inconvenient to require a user to determine when two ounces are left in a can and require the user not to drink that amount. As compared to typical diet programs, it is even more unrealistic to convert calorie limitations into portion sizes of particular foods. Such an exercise generally requires a calculator, a good deal of memorization, and strong determination.

In one exemplary implementation of a weight maintenance program using the portion measuring devices described above, a user of the program is instructed to eat three meals a day as normal. The user is also encouraged to eat the foods the user normally eats and likes to eat. However, the program restricts the user to eating only 6 portions of foods falling into the portion control categories (i.e., carbohydrates, saucy dishes, baked goods, meat, dairy, toppings, goodies, and liquids) across the three meals in a day. In addition to the three meals, a user of the program may also have one snack or dessert during a day, but limited to the portion size of the baked goods scoop or goodies scoop.

In addition to portioned foods measured by the measuring devices, a user of the program may eat and drink as much “free food” and “free liquid” as desired throughout any day. There are many free foods in the program, including all fruits, all vegetables, and most low fat dairy. These foods are free because they have a relatively small amount of fat and sugar in them compared to other foods. Thus, free foods have less calories than most other foods. But the program is about portion control, not counting calories. So free foods are those foods can be eaten in large amounts before the calories start piling up. Also, by calling these foods free as opposed to telling a person that he or she “should” eat more fruits and vegetables, a person is gently guided to eating more fruits and vegetables without the psychological stress of “having” to eat something or being “forced” to eat something.

Free foods take advantage of the body's treatment of carbohydrates while the portion sizes take advantage of the body's treatment of fat. Exemplary free foods under the program may include, for example, all fruits, all vegetables (including clear vegetable soups and vegetable sauces), broth soups (without noodles), condiments (excluding mayonnaise), low-fat dairy foods (yogurt, 1%-2% milk, and cottage cheese), low-fat salad dressings, coffee, tea, and water.

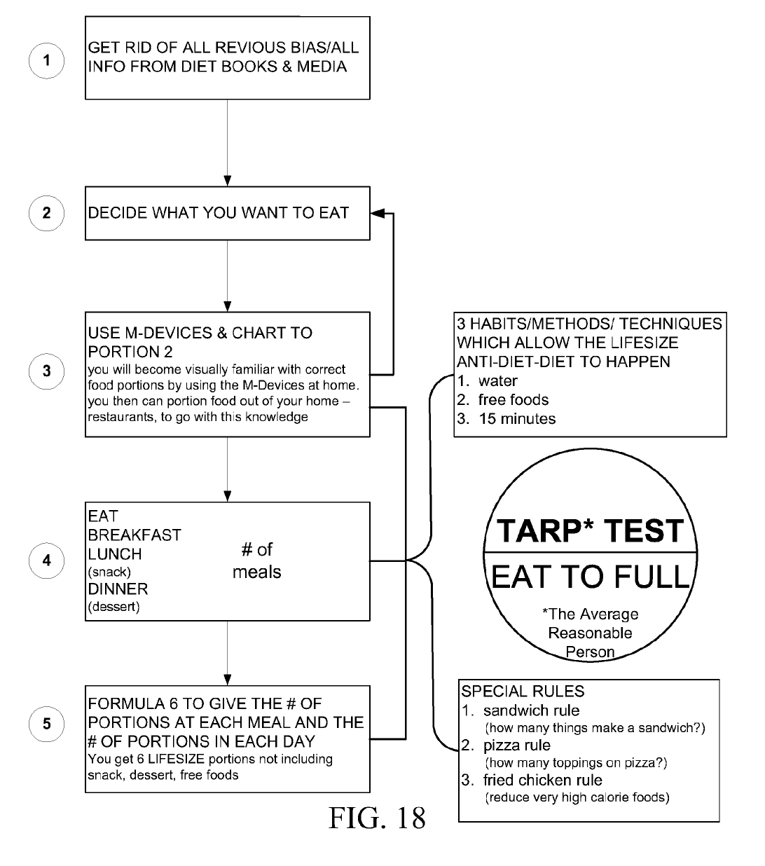

As represented in FIG. 18, the weight loss and weight maintenance program disclosed herein trains a person to give up his or her prejudices about food, e.g., that fat is bad or certain foods have too many calories. The program allows a person to eat the foods they really love and want to eat. This psychological part of the program is designed to remove feelings of guilt, stress, and deprivation one typically experiences on a diet and other weight loss programs. As a person eats the food they love in the smaller portions provided by the portion scoops, the daily calorie, carb and fat intake of an overweight person is reduced. The proper portions of food are clearly shown and easy to portion out using the measuring devices and wall chart.

The program further limits caloric intake by portioning the number of times a person eats in a day, and by limiting the number of portions of food a person eats in a day and in a meal. The program suggests eating three meals a day plus a snack and/or dessert. On days that a user exercises, both a snack and a dessert are allowed. On days a user doe not exercise you can also have a snack or a dessert. This daily eating structure of three meals is the best schedule for weight loss (as opposed to eating 6 smaller meals a day, which keeps people eating, focused on eating, and potentially disrupts their day). The snack and/or dessert are not counted as one of the 6 portions under the program. The program user should only have to divide 6 portions over three daily meals.

The 6 portions minimize the math and calculations a person would have to do during a meal and day with their food. Math and eating do not mix well and cause stress and obsessing about how much food a person is eating. Also, 6 portions, divided over 3 meals, is such a small number that users find it much easier to remember how many portions of food they ate in a day, and easily plan out their eating strategy for the day juggling just 6 portions.

Further, to ease the calculations, all portions in the program are equal, regardless of the portion scoop used. For example, even though a portion of steak might have more food and calories than a portion of salad dressing, all portions are considered equal to each other, which makes it easier to remember and juggle just 6 portions over 3 meals. Program users are not forced to remember how many calories are in a food that they ate. People are not forced to calculate many numbers based on the calories they ate. Additionally, all fruits, all vegetables, and most low fat dairy is free. A person does not have to portion them out, and they do not have to count them as one of their 6 portions of food for the day.

In addition to portion control, the program encourages users to drink more water during the day; eat slower, and include more fruits and vegetables, low fat dairy, and other low calorie foods to eat during the day and in a meal.

For example, by drinking more water during the day whenever feeling hungry, most of the time a user will not be hungry afterward, because most of the time one is really just dehydrated. If still hungry, after drinking water one can eat. This habit will help a user stick to 3 meals plus a snack and/or dessert during the day.

The program also encourages users to wait 15 minutes for seconds after finishing a meal. If still hungry after waiting, a user can eat, but it is less likely that the user will be hungry. It takes about 15 minutes for the brain to receive the signal from the stomach that you have eaten food. Most of the time, after 15 minutes, the person won't be hungry anymore and will have limited their caloric intake to the portions under the program.

The program also allows a user to fill in with free foods. To help a person stick to eating smaller portions, the program is designed to take away any feelings of stress, deprivation and guilt found on most diets by allowing a person to eat a normal amounts of times during the day, i.e., 3 traditional meals plus a snack and or dessert.

The program further allows a person to eat various size meals during the day. A person can juggle the 6 portions over 3 meals. For example, a person can have a smaller breakfast using 1 portion, a normal lunch using 2 portions, and a larger dinner using 3 portions. This also recreates a typical American day of lighter breakfasts and larger dinners when a person has more time to eat with family or business associates.

Further, the program reduces the normal sensations of guilt associated with diets. Every portion is given equal weight. For example, a portion of salad dressing is equal to a portion of soda is equal to a portion of steak. Unlike other calorie-counting diets which claim to allow a person to eat whatever he or she wants, but then assigns weighted values do different foods based on calories, the present program takes away calorie counting. On other programs, for example, a sandwich has more “points” than a serving of soup which tends to make a person feel guilty if they have a sandwich instead of soup for lunch. A person has to make harder calculations as to what he or she should eat based on this weighted points system. And guilt plus difficulty of constantly calculating all the food a person eats leads to stress, which eventually leads to a person stopping their weight loss program.

The present program calculates caloric intake on a weekly basis, not a daily basis, so a person has the freedom to eat a little more on certain days which will leave them full and satisfied and also lead them to eat a little less on certain other days based on their hunger level and choice to eat all kinds of foods.

The portions were designed to lower a person's caloric intake by averaging calories across portions over a longer period of time while providing the user with a sense of freedom.

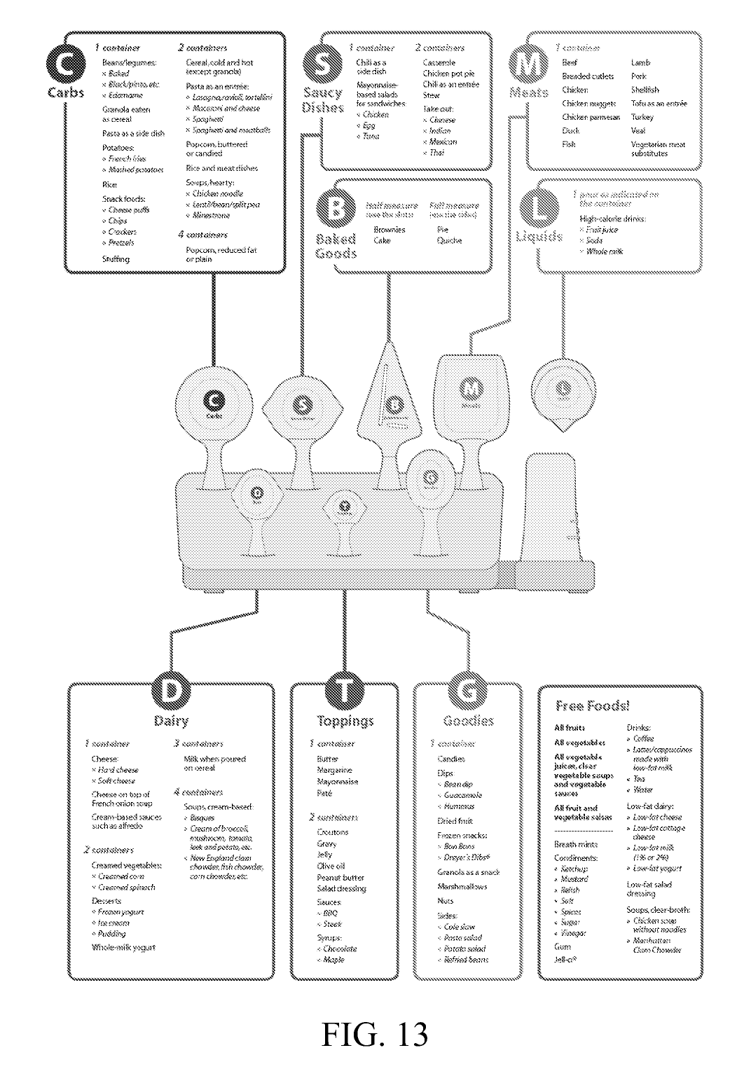

In addition to the measuring devices, the weight maintenance program may incorporate the use of a chart, for example, as shown in FIG. 13, to identify the common or exemplary foods in each food category subject to portioning by the measuring devices. Note that in addition to listing exemplary foods, the chart also indicates how many servings or “containers” of a particular measuring device constitutes a single portion for the particular food counted toward the 6 portion daily limit. Thus, for some foods, a single container-full of a measuring device constitutes one portion. However, for other foods 2, 3, or even 4 containers-full of a measuring device constitute a portion for purposes of the 6 portion daily limit at meals. For example, a single container-full of the toppings measuring device is a single portion for butter, but 2 containers-full of the toppings measuring device is a single portion for peanut butter.

Each measuring device may correspond to an area on the chart using a common referential indication. For example, the color and/or letter coding on the measuring devices described above may correspond to a similar color and/or letter-coded section in the chart listing common or exemplary foods within a food category. Foods in a particular category should be portioned using the corresponding measuring device. Other referential schemes for correlating the measuring devices to a listing of foods in corresponding categories may also or alternately be used.

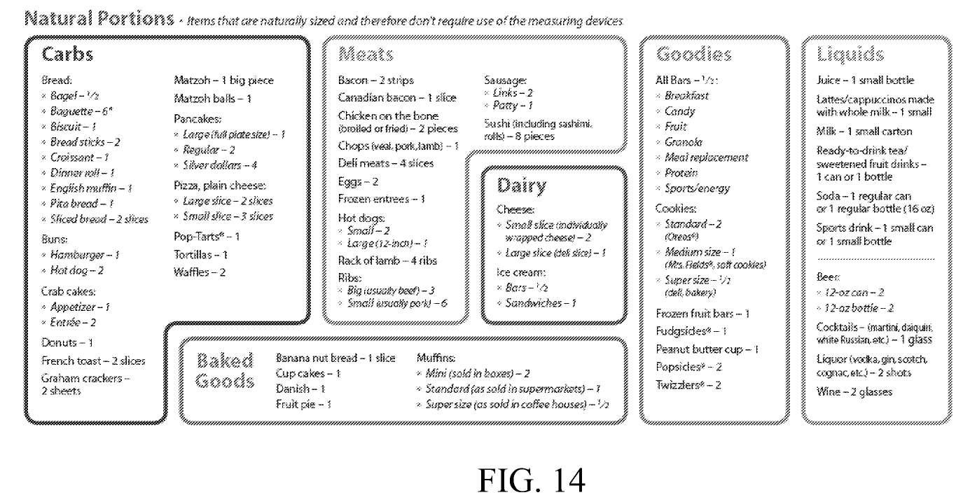

It is acknowledge that some foods do not easily lend themselves to portioning through the use of the measuring devices. An additional chart or section of the chart of FIG. 13 may be used to address this issue as depicted in FIG. 14. The chart of FIG. 14 describes “natural portions” of foods that are not easily measured in the measuring devices. For example, a natural portion of sliced bread is two slices and a natural portion of bacon is two slices. The natural portions chart may similarly be referentially coded to the corresponding food categories of the main chart by using a similar color, letter, or other symbol coding scheme.

In addition to portioning foods in the designated categories, the weight maintenance program also encourages increasing the user's consumption of water. Drinking water is a significant component in losing weight and maintaining proper weight. The body recognizes dehydration and hunger as the same thing. This means that many times when a person feels hungry, the person is actually just thirsty. So many times people eat food when their bodies actually wanted some water. Therefore, the recommendation is that whenever a user of the program feels hungry, the user should first drink some water. If after drinking some water, the user is still hungry, then the user should eat. However, many times the user will actually just be dehydrated, and after drinking water, the hunger sensation will disappear.

Similarly, the weight maintenance program also recommends taking a break after eating the prescribed portions for a meal measured by the measuring devices. By waiting for about 15 minutes after eating a meal of the portions described herein, a person may avoid overeating at a meal because the sensation of hunger will subside once the body recognizes that it has eaten enough carbohydrates, fats, proteins, and nutrients and sends signals to the body systems so a person senses that he or she is “full.”. If the program user is still hungry after waiting for this short period and drinking a glass of water, the program recommends eating additional free foods until the user feels satisfied.

For overweight users of the system, the measuring devices will provide smaller portions of food than what these users presently consume. However, these portion sizes are likely larger than the amount of food provided in a typical calorie-restricted diet plan. This is due to the way the portion sizes of food are calculated—using physiological and psychological considerations as well as caloric information—that simplifies the measurement of food for achieving weight loss. For example, there is no requirement to track intake of carbohydrates, fat, sugar, or metabolic weight as in typical diet plans or programs. The big picture is portion size, not these other details. If a person eats more calories than expended, the result is weight gain. If person eats less calories than burned, the result is weight loss. And if a person balances the amount of calories eaten with the amount of calories you expended, the result is weight maintenance. However, a calorie cannot be seen, but the size of a food portion on a plate can. Thus, the easiest way to reduce calorie intake is to reduce the amount of food eaten through portion control.

The weight loss program using portion control measuring devices as disclosed herein is different from known weight loss and weight management programs for several reasons. First, the program does not deprive users of certain types of food. Users are free to eat whatever they want to eat and like to eat. The only restriction is on the amount of food. This offers a significant psychological benefit to users of the program because they do not have a sense of deprivation. Second, the program does not require a change in eating habits or lifestyle. Users are still able to eat a normal three meals a day and also have a snack and/or dessert if desired. In fact a user can still eat out at a restaurant if the user limits the portion sizes consumed to what is allowed by the measuring devices. The remaining food may be taken home in a doggie bag for another meal. Third, the portion sizes are generally larger than typical calorie allotments of known diet plans. This reduces the risk that a user will experience significant cravings. Thus, the program results in gradual weight loss for users that are overweight, but at a slower rate that typical diet plans that severely restrict caloric intake. So while a person might lose weight more slowly than on a typical diet, a person will tend to stick to this eating program for life.

The portion sizes imposed by the measuring devices in the program are the same for both men and women. While this may seem counterintuitive due to the general differences in size, build, and body structures of men and women, in actuality it makes sense when human physiology is considered. If fat intake as a percentage of food consumed is high, the metabolic rate of a person is likely to remain in a low state. However, if fat intake and total calorie intake are reduced, the metabolic rate increases significantly and begins to burn stored calories in the form of fat. As body fat and weight decrease and the metabolic rate increases, food cravings decrease. The portion sizes for the designated food categories therefore push users to eat the free foods described above that are low calorie, but higher in carbohydrate content. The greater intake of these kinds of foods triggers an increase in the metabolic rate of the user, which in turn helps to burn more calories that are stored as fat.

It should be noted that most men will lose weight on the program faster than most women because of the differences in physiology between the sexes. The metabolic rate of men is generally higher than the metabolic rate of women. However, both women and men can reach healthy weights following the program and maintain those healthy weights by continuing to eat the portion sizes prescribed by the measuring devices for the food categories of the program and additional free foods as desired. Men on the program may need to eat a larger quantity of free foods because the carbohydrate requirement of the typical male metabolic rate is higher. A male on the program may thus feel more hungry or less satisfied unless his intake of free foods is higher than the typical female intake of free foods. Additionally, a male may crave richer of higher fat foods that will make up some additional calories to fuel the higher metabolism. The program is meant to be a lifestyle or habit change that is continued throughout life to maintain a healthy weight.

All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. An apparatus for use in a weight loss and weight maintenance program comprising a set of volumetric measuring devices, wherein
each measuring device is configured to measure a single portion size for any particular food in a respective category of food such that an actual calorie value of the single portion size for the particular food will be substantially within a range of calories selected to result in weight loss and weight maintenance based upon caloric intake over an extended period of time;
each category of food is associated with one of the volumetric measuring devices in the set; and
the single portion size for any particular food is volumetrically measured by a respective one of the measuring devices corresponding to the category for the particular food without regard to determining and considering the actual calorie value of the single portion size of the particular food.

2. The apparatus of claim 1, wherein each measuring device is sized to produce in conjunction with others of the measuring devices a base daily intake of between 1600 and 2000 calories based solely upon a maximum number of daily portions prescribed by the program.

3. The apparatus of claim 2, wherein the maximum number of daily portions is six.

4. The apparatus of claim 1 further comprising a chart depicting
the respective categories of food;
a listing of particular foods in each category of food; and
a number of volumes of each respective measuring device corresponding to the single portion size for each particular food.

5. The apparatus of claim 1, wherein the measuring devices are correlated with the categories of foods depicted on the chart.

6. The apparatus of claim 5, wherein the measuring devices are correlated by a color code for each category whereby each category is presented in a color on the chart and each corresponding volumetric measuring device has a corresponding.

7. A set of portion scoops for use in a weight loss and weight management program comprising
respective bodies for each of the portion scoops in the set, each body defining a filling and dispensing aperture and a storage volume, wherein
the storage volume of each respective portion scoop is determined to measure portions of cooked or prepared foods within a range of calories selected to result in weight loss and weight maintenance based upon an average caloric intake from a daily maximum of portions over an extended period of time; and
the cooked or prepared foods are classified within respective categories corresponding to each respective portion scoop; and
a label on each respective portion scoop identifying a respective category of cooked or prepared foods for which each respective portion scoop is intended to measure out.

8. The set of portion scoops of claim 7, wherein the categories of cooked or prepared food comprise one or more of the following classifications: carbohydrates, saucy dishes, baked goods, meats, dairy, toppings, goodies, and liquids.

9. A method for weight loss and weight maintenance comprising
providing a set of volumetric food measuring devices, each food measuring device in the set corresponding to a respective category of food and configured to dispense any food within the respective category of food substantially within a set range of calories;
measuring a single portion size for any particular food in the respective category of food using a corresponding one of the volumetric food measuring devices in the set regardless of an actual calorie value of the single portion size for the particular food; and
limiting a number of portions measured by for consumption by a user in a single day.

10. The method of claim 9, wherein a single portion size for the particular food is more than one volume of the particular food as measured by the corresponding one of the volumetric food measuring devices.

11. The method of claim 9 further comprising limiting the number of portions to six in a single day.

12. The method of claim 9 further comprising spreading the six portions across three standard meals in the single day.

13. The method of claim 9 further comprising allowing a serving of an additional portion in a single day if the user compensates for the additional portion by performing a prescribed amount of exercise.

14. The method of claim 9 further comprising allowing the user to consume unlimited amounts of free foods in addition to the limited number of portions of foods associated with each respective category of food.

15. The method of claim 9, wherein there is no limitation on type of food that can be portioned by the set of volumetric food measuring devices.

16. The method of claim 9 further comprising dispensing to the user via the set of volumetric food measuring devices an average caloric intake determined to effect weight loss and weight maintenance in the user over a period of time extending beyond a single day.

17. The method of claim 9 further comprising educating the user as to appropriate portion sizes for each respective category of food to achieve weight loss and weight management through visual reinforcement of portion sizes as dispensed by the volumetric food measuring devices corresponding to each respective category of food.

18. A system for weight loss and weight management comprising
a set of food portioning scoops of varied respective volumes for serving foods;
a categorization of foods wherein each category further corresponds to a selection of foods related by a schema for portioning using a particular one of the portioning scoops; and
a respective identification on each scoop in the set of food portioning scoops corresponding to a respective category for portioning.

19. The system of claim 18, wherein the categorization of foods is presented in a chart.

20. The system of claim 19, wherein
the categorization of foods on the chart is presented in a color code for each category; and
the identification on each scoop in the set of food portioning scoops is at least partially in the form of the color code and corresponds to a respective category.
